(19) United States
(12) Patent Application Publication
(10) Pub. No.: US 2025/0047952 A1
(43) Pub. Date: Feb. 6, 2025

(54) USER INTERFACE RESPONSIVE TO BACKGROUND VIDEO

(71) Applicant: ROKU, INC., San Jose, CA (US)

(72) Inventors: Christopher James TEGETHOFF, Portland, OR (US); Andrew Taiquan LU, San Jose, CA (US)

(73) Assignee: ROKU, INC., San Jose, CA (US)

(21) Appl. No.: 18/927,516

(22) Filed: Oct. 25, 2024

Related U.S. Application Data
(63) Continuation of application No. 17/695,527, filed on Mar. 15, 2022.

(51) Int. Cl. H04N 21/488; G06F 3/048; H04N 21/431; H04N 21/485; H04N 23/63

(52) U.S. Cl. CPC H04N 21/488; G06F 3/048; H04N 21/4316; H04N 21/4854; H04N 23/631

(57) ABSTRACT

Disclosed herein are system, apparatus, article of manufacture, method and/or computer program product embodiments, and/or combinations and sub-combinations thereof, for modifying one or more parameters of graphical overlays to increase readability when arranged over a very visually noisy display screen. An example embodiment operates by determining a graphic rendering area and position within a video frame of a graphical overlay, calculating a location of video sub-blocks located in another layer of the video frame, wherein the video sub-blocks at least partially obfuscate the graphical overlay during rendering, evaluating a histogram of the video sub-blocks aligned with the graphic rendering area and selecting, based on a histogram value being above a threshold histogram value, a second graphic rendering area, and relocating the graphic overlay to the second graphic rendering area.

### CROSS-REFERENCE TO RELATED APPLICATIONS

This application is a continuation of U.S. patent application Ser. No. 17/695,527, filed Mar. 15, 2022, the contents of which are incorporated herein by reference in its entirety.

### BACKGROUND

### Field

This disclosure is generally directed to display screen technology, and more particularly to media content overlays for a display screen.

### Background

Media content, such as a movie or TV show, is typically displayed on a television or other display screen for watching by users. However, when regular programming or other screen imagery includes an overlay of additional imagery, such as a user interface, it may be difficult for the user to properly visualize the information when two or more layers of imagery (e.g., video and user interface) are competing for the same display space.

### SUMMARY

Provided herein are system, apparatus, article of manufacture, method and/or computer program product embodiments, and/or combinations and sub-combinations thereof, for modifying one or more parameters of graphical overlays to increase readability when arranged over a visually noisy display screen. Readability refers to how easy it is to read and understand, depending on a display object's unique features.

The technology as described herein, in some embodiments, may be configured to improve presentation of any graphical overlay (e.g., user interface) arranged over existing displayed content to make the information presented more legible and more easily understood. In some embodiments, the technology may be applied broadly to any configurable aspect of a graphic overlay based on analyzing the image or video that is being displayed underneath it.

### BRIEF DESCRIPTION OF THE FIGURES

The accompanying drawings are incorporated herein and form a part of the specification.

FIG. 1 illustrates a block diagram of a multimedia environment, according to some embodiments.

FIG. 2 illustrates a block diagram of a streaming media device, according to some embodiments.

FIG. 3 illustrates a process diagram of a graphic overlay opacity modification, according to some embodiments.

FIG. 4 illustrates a multiple sectioned display screen before overlay, according to some embodiments.

FIG. 5 illustrates a display screen of a graphic overlay before opacity modification, according to some embodiments.

FIG. 6 illustrates a display screen of a graphic overlay after opacity modification, according to some embodiments.

FIG. 7 illustrates a multiple sectioned display screen before overlay, according to some embodiments.

FIG. 8 illustrates a display screen of a graphic overlay before opacity modification, according to some embodiments.

FIG. 9 illustrates a display screen of a graphic overlay after opacity modification, according to some embodiments.

FIG. 10 illustrates a display screen of a graphic overlay after position modification, according to some embodiments.

FIG. 11 illustrates a display screen with an evaluation area to detect contrast information, according to some embodiments.

FIG. 12 illustrates a display screen with resulting detected contrast information, according to some embodiments.

FIG. 13 illustrates a graphic processor, according to some embodiments.

FIG. 14 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for modifying one or more parameters of a graphical overlay to increase readability when arranged over a visually noisy display screen.

In some embodiments, brightness and contrast levels of a display background layer are analyzed as they may interfere with readability of an overlay. For example, a display background is evaluated without the overlay with an opacity of the overlay subsequently modified based on the brightness and contrast level values measured.

In some embodiments, video reflects live television or streaming video playing in the background layer. A graphical overlay is a graphic screen used to make the text and graphics displayed on a foreground layer legible over a background video. A brightness score is a scale of 0-100 that measures the brightness of the background video. A contrast score is a scale of 0-100 that measures the contrast levels of the background video. A 100% opacity means the graphical overlay is completely opaque, while 0% opacity means the graphical overlay is completely transparent. In a non-limiting example, a UI may be rendered with an opacity lower than 100% and be obfuscated, at least partially, by video frame layers below the UI. In this scenario, the UI may provide media content control information for a viewer of the display screen, but may be difficult to read.

In some embodiments, a graphics processing system registers various media content layers of a video frame. However, when a UI of less than 100% opacity is to be overlaid onto a display screen where text or graphics are to be displayed, the readability of the UI may be diminished. In the technology described herein, a contrast level of the UI is modified to increase the readability (i.e., text and images are more legible).

In another non-limiting example, the technology described herein programmatically configures a television closed-caption overlay to appear more opaque over a visually noisy screen such as a newscast “breaking news” section at a bottom of a display screen to make it easier for a viewer to read. Captioning may include closed captions primarily intended for people who are hearing impaired or deaf. Closed captioning reflects hidden captions, until they are otherwise ‘opened’ by the viewer from a menu. Open captioning may include subtitles as an integral part of a film or video and cannot be closed off from view as they are embedded in the video. Dynamic text may include closed captions that arrive from within the live TV broadcast or data stream as separate data that can be formatted.

In some embodiments, television video post-processing systems are configured to enhance picture quality of the graphic overlay before video is rendered to the television (TV). The technology described herein may be configured to measure contrast values (local contrast), create a histogram of different areas of a display screen and process the histogram to determine if an opacity of a graphic overlay needs to be modified.

In some embodiments, contrast levels of a video background layer are analyzed relative to existing opacity levels of a graphical overlay to determine an optional placement of the graphical overlay. In a non-limiting example, a graphical overlay that is arranged in the video frame to overlap a visually busy section of the existing display screen is relocated to a non-overlapping or less busy section. In another non-limiting example, the opacity of the graphical overlay is increased but, to allow readability of underlying media content, the opacity remains at least partially transparent (e.g., less than 100% opacity) to still allow the viewer to see the underlying media content.

In some embodiments, contrast levels of a video background layer are analyzed relative to existing opacity levels of an existing graphical overlay to determine an optional placement of one or more sections of the underlying imagery. In a non-limiting example, a breaking news section located under a graphical overlay may be processed to ascertain displayable text and this text relocated to another non-overlapping position.

In some embodiments, contrast levels of a video background layer are analyzed relative to existing opacity levels of a graphical overlay and a viewer vision consideration to determine an optional placement of the graphical overlay. In a non-limiting example, a graphical overlay that overlaps a visually very busy section of the existing display screen is modified to improve readability to a user with diminished vision.

In a non-limiting example, a graphical overlay content box may appear in a middle of a webpage, obscuring background content. The technology described herein programmatically configures a graphics processing system to modify the contrast of the graphical overlay content box to appear more opaque over a visually noisy screen to make it easier for a viewer to read. Website overlays may also be commonly referred to as dialog boxes, modal windows, popups, etc.

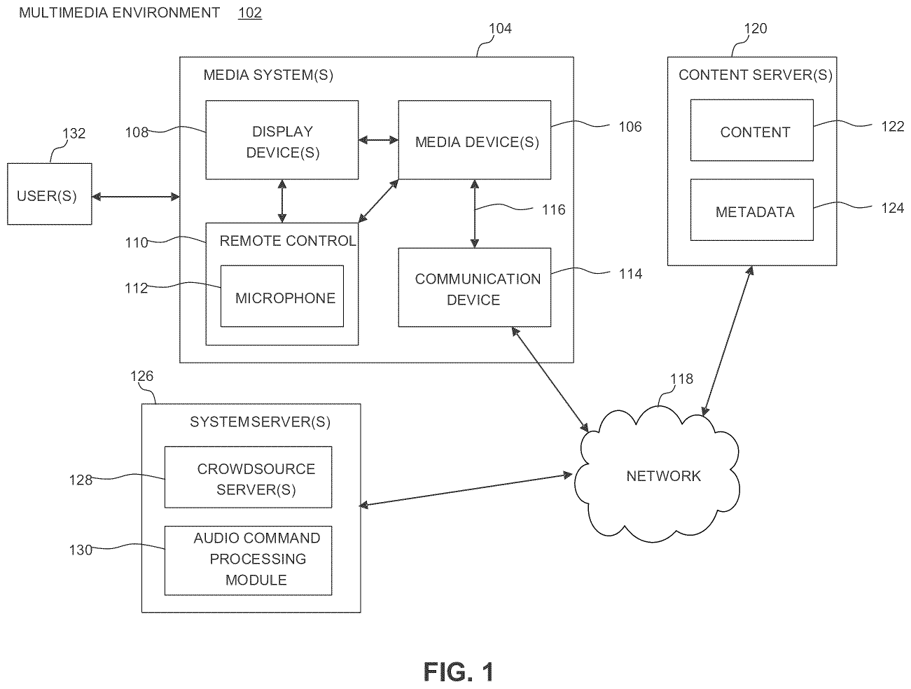

Various embodiments of this disclosure may be implemented using and/or may be part of a multimedia environment 102 shown in FIG. 1. It is noted, however, that multimedia environment 102 is provided solely for illustrative purposes, and is not limiting. Embodiments of this disclosure may be implemented using and/or may be part of environments different from and/or in addition to the multimedia environment 102, as will be appreciated by persons skilled in the relevant art(s) based on the teachings contained herein. An example of the multimedia environment 102 shall now be described.

### Multimedia Environment

FIG. 1 illustrates a block diagram of a multimedia environment 102, according to some embodiments. In a non-limiting example, multimedia environment 102 may be directed to streaming media. However, this disclosure is applicable to any type of media (instead of or in addition to streaming media), as well as any mechanism, means, protocol, method and/or process for distributing media.

The multimedia environment 102 may include one or more media systems 104. A media system 104 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 132 may operate with the media system 104 to select and consume content.

Each media system 104 may include one or more media devices 106 each coupled to one or more display devices 108. It is noted that terms such as “coupled,” “connected to,” “attached,” “linked,” “combined” and similar terms may refer to physical, electrical, magnetic, logical, etc., connections, unless otherwise specified herein.

Media device 106 may be a streaming media device, DVD or BLU-RAY device, audio/video playback device, cable box, and/or digital video recording device, to name just a few examples. Display device 108 may be a monitor, television (TV), computer, touch screen, smart phone, tablet, wearable (such as a watch or glasses), virtual reality (VR) headset, appliance, internet of things (IoT) device, automotive display, gaming display, heads-up display (HUD), and/or projector, to name just a few examples. In some embodiments, media device 106 can be a part of, integrated with, operatively coupled to, and/or connected to its respective display device 108.

Each media device 106 may be configured to communicate with network 118 via a communication device 114. The communication device 114 may include, for example, a cable modem or satellite TV transceiver. The media device 106 may communicate with the communication device 114 over a link 116, wherein the link 116 may include wireless (such as WiFi) and/or wired connections.

In various embodiments, the network 118 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 104 may include a remote control 110. The remote control 110 can be any component, part, apparatus and/or method for controlling the media device 106 and/or display device 108, such as a remote control, a tablet, laptop computer, smartphone, wearable, on-screen controls, integrated control buttons, audio controls, or any combination thereof, to name just a few examples. In an embodiment, the remote control 110 wirelessly communicates with the media device 106 and/or display device 108 using cellular, Bluetooth, infrared, etc., or any combination thereof. The remote control 110 may include a microphone 112, which is further described below.

The multimedia environment 102 may include a plurality of content servers 120 (also called content providers or sources). Although only one content server 120 is shown in FIG. 1, in practice the multimedia environment 102 may include any number of content servers 120. Each content server 120 may be configured to communicate with network 118.

Each content server 120 may store content 122 and metadata 124. Content 122 may include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 124 comprises data about content 122. For example, metadata 124 may include associated or ancillary information indicating or related to writer, director, producer, composer, artist, actor, summary, chapters, production, history, year, trailers, alternate versions, related content, applications, and/or any other information pertaining or relating to the content 122. Metadata 124 may also or alternatively include links to any such information pertaining or relating to the content 122. Metadata 124 may also or alternatively include one or more indexes of content 122, such as but not limited to a trick mode index.

The multimedia environment 102 may include one or more system servers 126. The system servers 126 may operate to support the media devices 106 from the cloud. It is noted that the structural and functional aspects of the system servers 126 may wholly or partially exist in the same or different ones of the system servers 126.

The media devices 106 may exist in thousands or millions of media systems 104. Accordingly, the media devices 106 may lend themselves to crowdsourcing embodiments and, thus, the system servers 126 may include one or more crowdsource servers 128.

For example, using information received from the media devices 106 in the thousands and millions of media systems 104, the crowdsource server(s) 128 may identify similarities and overlaps between closed captioning requests issued by different users 132 watching a particular movie. Based on such information, the crowdsource server(s) 128 may determine that turning closed captioning on may enhance users' viewing experience at particular portions of the movie (for example, when the soundtrack of the movie is difficult to hear), and turning closed captioning off may enhance users' viewing experience at other portions of the movie (for example, when displaying closed captioning obstructs critical visual aspects of the movie). Accordingly, the crowdsource server(s) 128 may operate to cause closed captioning to be automatically turned on and/or off during future streaming's of the movie.

The system servers 126 may also include an audio command processing module 130. As noted above, the remote control 110 may include a microphone 112. The microphone 112 may receive audio data from users 132 (as well as other sources, such as the display device 108). In some embodiments, the media device 106 may be audio responsive, and the audio data may represent verbal commands from the user 132 to control the media device 106 as well as other components in the media system 104, such as the display device 108.

In some embodiments, the audio data received by the microphone 112 in the remote control 110 is transferred to the media device 106, which is then forwarded to the audio command processing module 130 in the system servers 126. The audio command processing module 130 may operate to process and analyze the received audio data to recognize the user 132's verbal command. The audio command processing module 130 may then forward the verbal command back to the media device 106 for processing.

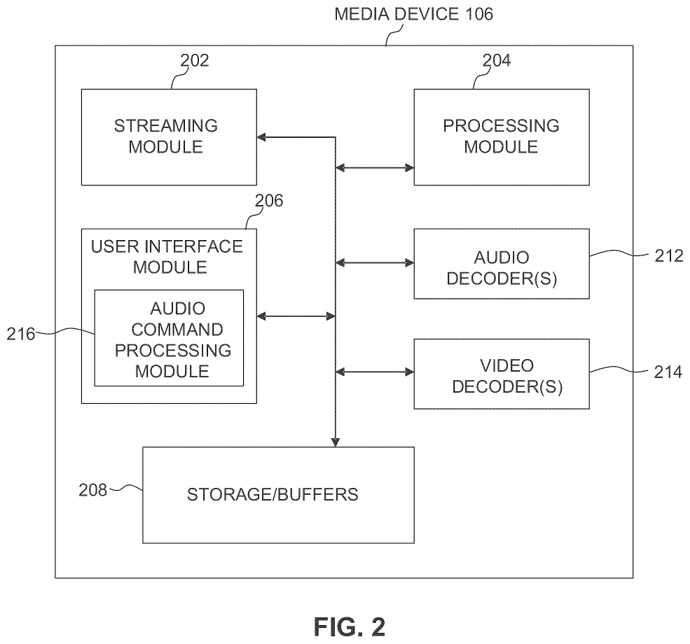

In some embodiments, the audio data may be alternatively or additionally processed and analyzed by an audio command processing module 216 in the media device 106 (see FIG. 2). The media device 106 and the system servers 126 may then cooperate to pick one of the verbal commands to process (either the verbal command recognized by the audio command processing module 130 in the system servers 126, or the verbal command recognized by the audio command processing module 216 in the media device 106).

FIG. 2 illustrates a block diagram of an example media device 106, according to some embodiments. Media device 106 may include a streaming module 202, processing module 204, storage/buffers 208, and user interface module 206. As described above, the user interface module 206 may include the audio command processing module 216.

The media device 106 may also include one or more audio decoders 212 and one or more video decoders 214.

Each audio decoder 212 may be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 214 may be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 214 may include one or more video codecs, such as but not limited to H.263, H.264, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1 and 2, in some embodiments, the user 132 may interact with the media device 106 via, for example, the remote control 110. For example, the user 132 may use the remote control 110 to interact with the user interface module 206 of the media device 106 to select content, such as a movie, TV show, music, book, application, game, etc. The streaming module 202 of the media device 106 may request the selected content from the content server(s) 120 over the network 118. The content server(s) 120 may transmit the requested content to the streaming module 202. The media device 106 may transmit the received content to the display device 108 for playback to the user 132.

In streaming embodiments, the streaming module 202 may transmit the content to the display device 108 in real time or near real time as it receives such content from the content server(s) 120. In non-streaming embodiments, the media device 106 may store the content received from content server(s) 120 in storage/buffers 208 for later playback on display device 108.

### Overlay Modification

The technology as described herein, in some embodiments, may be configured to improve presentation of any graphical overlay (e.g., UI) arranged over existing displayed content to make the information presented more legible and more easily understood. In some embodiments, the technology may be applied broadly to any configurable aspect of a graphic overlay based on analyzing the image or video that is being displayed underneath it.

In some embodiments, brightness and contrast levels of a video background layer are analyzed relative to existing opacity levels of a graphical overlay (e.g., UI). Contrast is defined as a difference in brightness between objects or regions. Brightness refers to an overall lightness or darkness of an image. A contrast ratio is a ratio between luminance of a brightest white and a darkest black that a display (e.g., TV) can produce. When a graphic is to be overlaid onto the display screen where other imagery are to be displayed, the readability of the graphic may be diminished. In the technology described herein, an opacity level of the graphic overlay is modified to increase the readability (i.e., text and/or images become more legible).

Graphic overlays may be more broadly defined as any media content that occupies a media content layer above any lower media content layer and visually competes for at least a partial section of a display screen. The media content can comprise any known or future content items such as, but limited to, streaming digital media, video, images, graphics, smartphone notifications, on-screen menus, sprites, moving content (e.g., tickers commonly found at a perimeter of a display screen), closed captioning, open captioning, dynamic text, blank space, emergency messages, sports scores, weather or time information. In addition, the technology described herein is not limited to a single interaction of two media content layers, or a specific number of overlays, but may be applied to any number of media content layers or overlays. In one non-limiting example, a first overlay may visually intersect with a lower media content layer, and visually intersect with a second overlay positioned on higher or lower media content layers.

Referring to FIG. 1, display devices 108 may be configured with graphics processing elements. For purposes of explanation and simplicity, display devices 108 will be described hereafter in a singular reference-display device 108. As such, display devices 108 and display device 108 are considered interchangeable.

In one non-limiting example, display device 108 is configured with a graphics processor, such as a graphics accelerator, video processor, System On a Chip (SOC), a TV SOC, video card, gaming processor, etc., as is known. While a graphics processor is described herein as part of display device 108, one or more graphics processing steps may be performed external to the display device 108. In one non-limiting example, graphics processing may be performed by television circuitry, a media device 106, a content server 120, a system server 126, a video card, a gaming processor card, ancillary computing devices of user 132 or a combination of any of these elements.

In some embodiments, post-processing video pipelines are configured for enhancing picture quality before video is rendered to a display panel. Accordingly, the display device 108 may lend itself to opacity modification embodiments as described herein.

In some embodiments, one or more graphics processors operate to programmatically edit closed caption overlays to be of a higher opacity when arranged over a visually noisy media content rendered on a display screen. For example, using a video post-processing pipeline, picture quality (e.g., of a graphics overlay) is enhanced before media content is rendered to the display device 108.

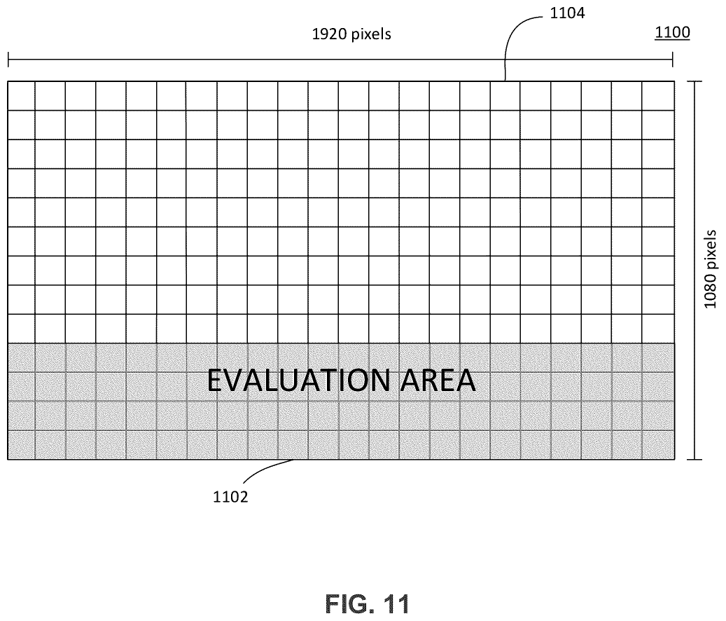

The technology described herein, in one non-limiting example, analyzes one or more areas (e.g., evaluation zones) of a display screen (FIG. 11) to evaluate contrast levels of potentially overlapping areas of the display screen. Evaluation zones may include X and Y values and absolute positioning of the area on a video being measured. Based on this evaluation, the graphics processor may trigger increasing an opacity of at least one overlay to enhance a users' viewing experience by increasing readability of the overlay when the overlay is competing for busy, high contrast, display space on the display.

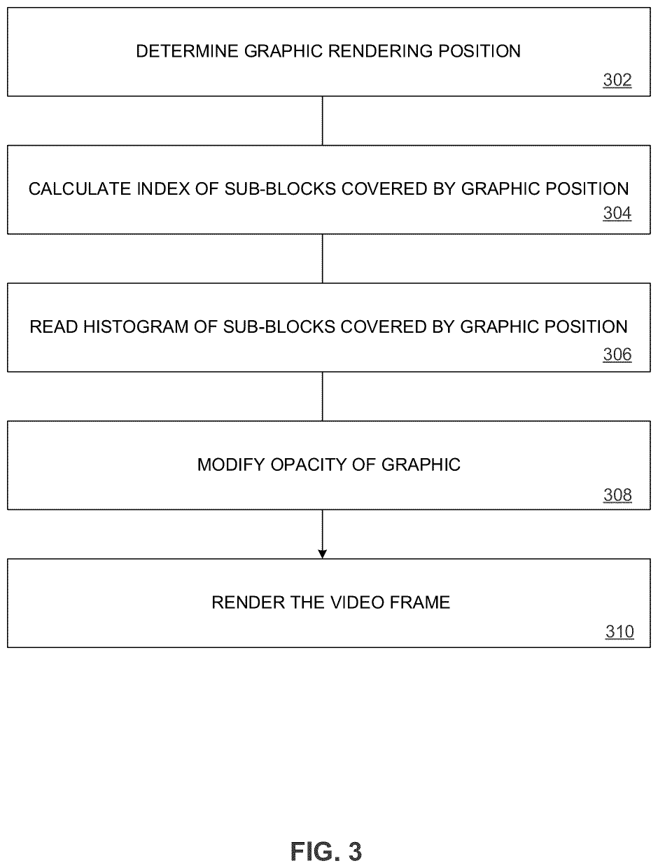

FIG. 3 illustrates a flow diagram of a graphical overlay opacity modification, according to some embodiments. Graphical overlay opacity modification may be implemented by graphics processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than described for FIG. 3, as will be understood by a person of ordinary skill in the art.

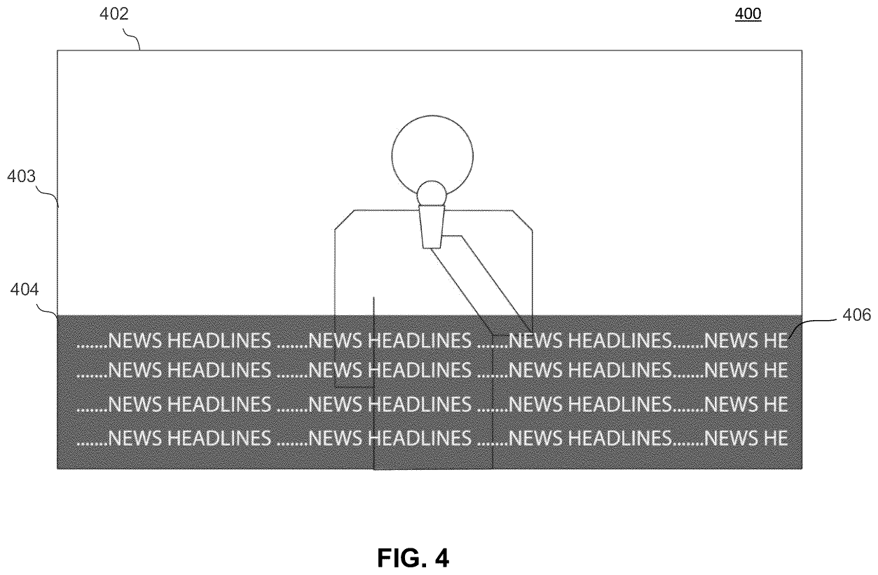

In 302, a graphics computing system determines, in advance of rendering, a graphic rendering position of a graphical overlay. For example, a graphic overlay will cover an area of M×N pixels of a display screen and at least partially obfuscate corresponding display screen pixels M¹×N¹ at a rendering position. In a non-limiting example, a graphical overlay will be rendered at the bottom of a news broadcast (FIGS. 4-10) and cover existing news updates to be rendered at the bottom of the display screen. While described as determining a graphic rendering position in advance of rendering, other approaches are considered within the scope of the technology described herein. For example, the determination may be made in real-time, such as just-in-time, or arranged within any part of the rendering process without departing from the scope of the technology described herein.

In 304, a graphics computing system calculates an index of sub-blocks covered (aligned) by the determined graphic at the rendering position. In a non-limiting example, the graphics computing system extracts addressing information (index) from a pixel table for display screen pixels M¹×N¹ at a rendering position.

In another non-limiting example, the graphics computing system extracts from a graphics buffer addressing information (i.e., index) for display screen pixels M¹×N¹ at a rendering position. In computing, a graphics buffer is a part of computer memory used by a computer application for the representation of the content to be shown on the computer display. A graphics buffer, sometimes called a screen buffer, framebuffer, frame buffer, regeneration buffer, regen buffer or framestore, is a portion of random-access memory (RAM) containing a bitmap that drives a video display. It is a memory buffer containing data representing all the pixels in a complete video frame (and may include one or more content layers). This circuitry converts an in-memory bitmap into a video signal that can be displayed on a computer display.

The information in the graphics buffer commonly consists of color values for every pixel to be shown on the display. Color values are commonly stored in 1-bit binary (monochrome), 4-bit palletized, 8-bit palletized, 16-bit high color and 24-bit true color formats. In some embodiments, an alpha channel is used to retain information about pixel transparency. The total amount of memory required for the framebuffer depends on a resolution of the output signal, and on the color depth or palette size.

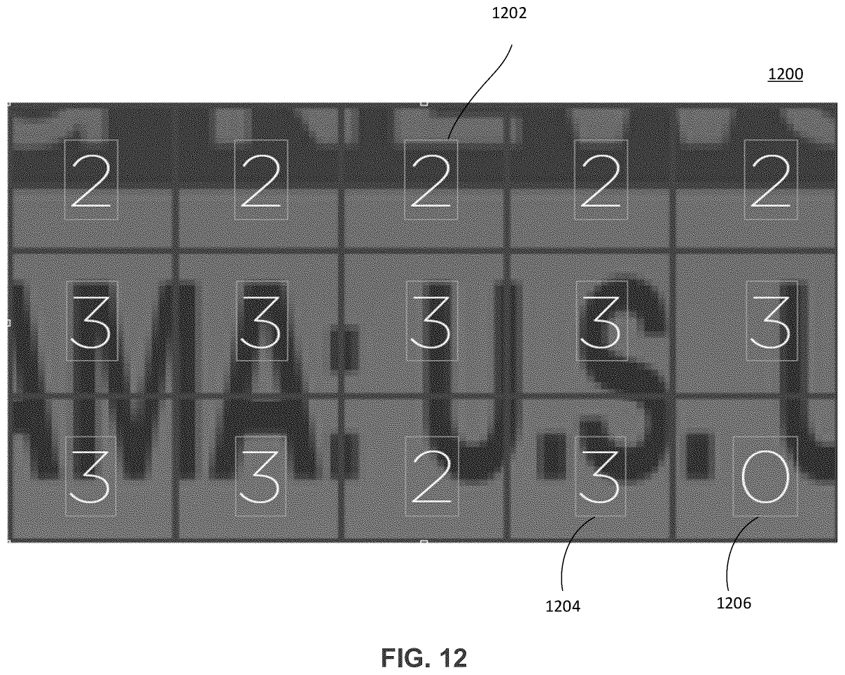

In 306, a graphics computing system reads (i.e., evaluates) a brightness and contrast histogram of sub-blocks covered by the graphic rendering position. In a non-limiting example, brightness and contrast information for underlying display screen pixels M¹×N¹ is captured at rendering position (FIG. 12). As an individual pixel of an underlying image may include image data, partial image data or no image data, and of varying brightness and contrast, histograms are used to provide a rough sense of the density of the underlying distribution of the data. A histogram provides an approximate representation of the distribution of the numerical data (e.g., frequency distribution). To construct a histogram, the first step is to “bin” (or “bucket”) the range of values—that is, divide the entire range of values into a series of intervals—and then count how many values fall into each interval. The bins are usually specified as consecutive, non-overlapping intervals of a variable. The bins (intervals) are adjacent and are often (but not required to be) of equal size.

In a non-limiting example, adjacent bins may be mapped to a scale. For example, as shown in FIG. 12, brightness and contrast information is bucketed into a scale of 0-3, where a scale value of 0 may reflect a low contrast difference and a scale of 3 may a high contrast difference. For example, a blank display area would have a low contrast difference and an area with text/graphics may be recognized as a high contrast area. One skilled in the art will appreciate that other scales or bucket labels (e.g., bright, dark, neutral, high contrast, no contrast, blank, etc.) may be substituted without departing from the scope of the present technology.

In 308, a graphics computing system modifies an opacity of the graphic overlay. For example, the graphics computing system generates a blending factor based on brightness and contrast contributions from both the underlying media content layer and the overlaid media content layer (e.g., UI overlay). To increase an opacity of the overlay layer, the system need only aggregate brightness and contrast values that cumulatively increase the perceived overall contrast of the overlay. The blending factor provides the graphic processing system with brightness/contrast settings to modify the pixels of the overlay layer. In the blending factor, contrast setting adjusts the bright parts of the image, while the brightness setting adjusts the dark parts. Increasing the contrast level will result in brighter highlights and darker darks.

In 310, the graphics computing system renders the frame on the display screen, with the underlying media content and modified opacity of the graphic overlay. To the user, the aggregated brightness and contrast values from multiple layers appears as an opaque upper layer in areas of darker colors.

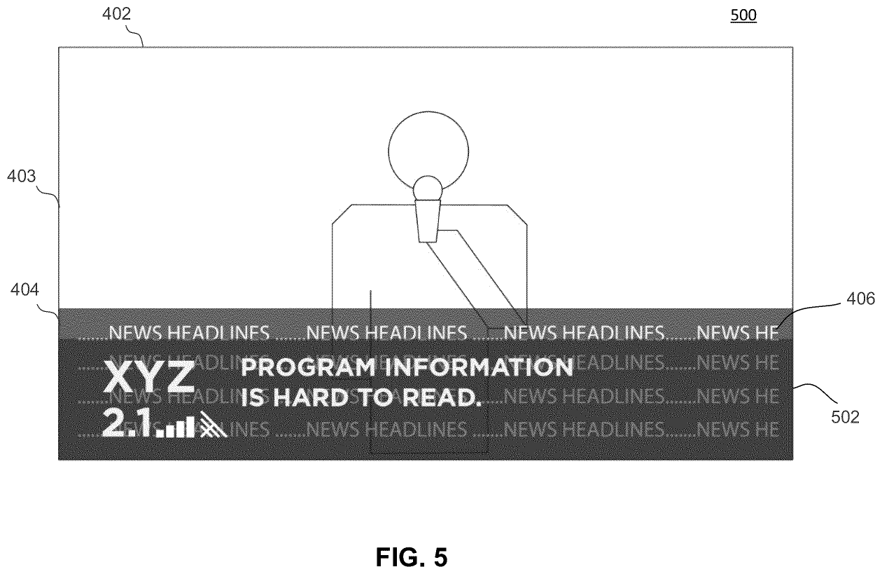

FIG. 4 illustrates a display screen 400 before adding a graphic overlay, according to some embodiments. Display device 108 is capable of displaying media content, such as video and/or graphic data as imagery on the display device. In an exemplary embodiment, one or more areas (sections) of display device 108 are arranged during display of the media content to include at least one graphical user interface (GUI) overlapping or overlaying existing displayed media content (e.g., as shown in FIGS. 5-10 for a news broadcast). Display device 108 may include a display screen 400 area that may vary in size depending on the size of display device 108. Display device 108 may include any of the various display screens described in FIGS. 4-12.

As shown, display device 108 has a display area 402. In this non-limiting example, the media content includes a streamed or broadcast news report with multiple media content sections. In display area 403, a speaker may be discussing a news topic of interest. In display area 404, media content 406 may be displayed. However, as will be illustrated in FIG. 5, a graphic overlay in display area 404 may compete with the media content 406.

While shown in FIGS. 4-12 as a specific number of display screen sections with varying media content or menus, the display screen may be a single section or any number of sections, and positioned in any configuration, without departing from the scope of the technology described herein.

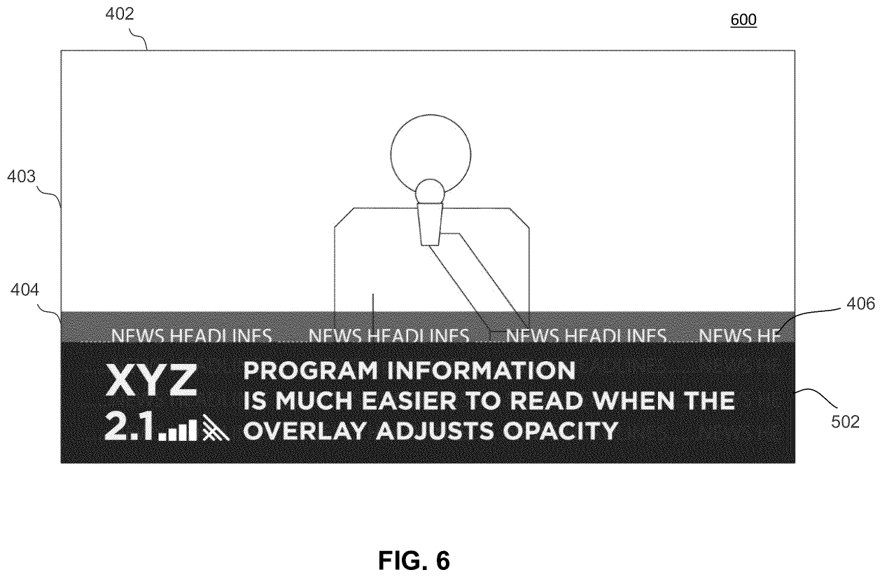

FIG. 5 illustrates a display screen 500 of a graphic overlay before opacity modification, according to some embodiments. The technology as described herein improves the readability of graphic overlay 502 by increasing opacity using a blending factor. As shown, display screen 500 has a display area 402. In this non-limiting example, the media content includes a streamed or broadcast news report with a multiple content sections. In display area 403, a speaker may be discussing a news topic of interest. In display area 404, media content 406 and a graphic overlay 502 at least partially occupy a same display area (intersection of 406 and 502) and compete for the viewer's attention. As will be shown in FIG. 6, the opacity of graphic overlay 502 may be adjusted to remove or reduce a level of transparency that permitted the lower underlying layer of media content 406 (e.g., text as shown) to visually interfere with a viewer's ability to read the graphic overlay. As shown, before an opacity adjustment (e.g., increase), the program information of overlay graphic 502 is hard to read.

As shown, the lower opacity of the graphic overlay creates a visual transparency that permits the lower underlying layer of media content 406 (e.g., news story text) to visually interfere with a viewer's ability to read the graphic overlay 502.

FIG. 6 illustrates a display screen 600 of a graphic overlay after opacity modification, according to some embodiments. The technology as described herein improves the readability of graphic overlay 502 by increasing opacity using a blending factor as previous described. As shown, display screen 600 has a display area 402. In this non-limiting example, the media content includes a streamed or broadcast news report with a multiple content sections. In display area 403, a speaker may be discussing a news topic of interest. In display area 404, media content 406 and a graphic overlay 502 at least partially occupy a same display area (intersection of 406 and 502) and compete for the viewer's attention. However, as shown, the opacity of graphic overlay 502 has been increased to remove or reduce a level of transparency that permitted the lower underlying layer of media content 406 (e.g., text as shown) to visually interfere with a viewer's ability to read the graphic overlay. In this scenario, the programming information of overlay graphic 502 is much easier to read.

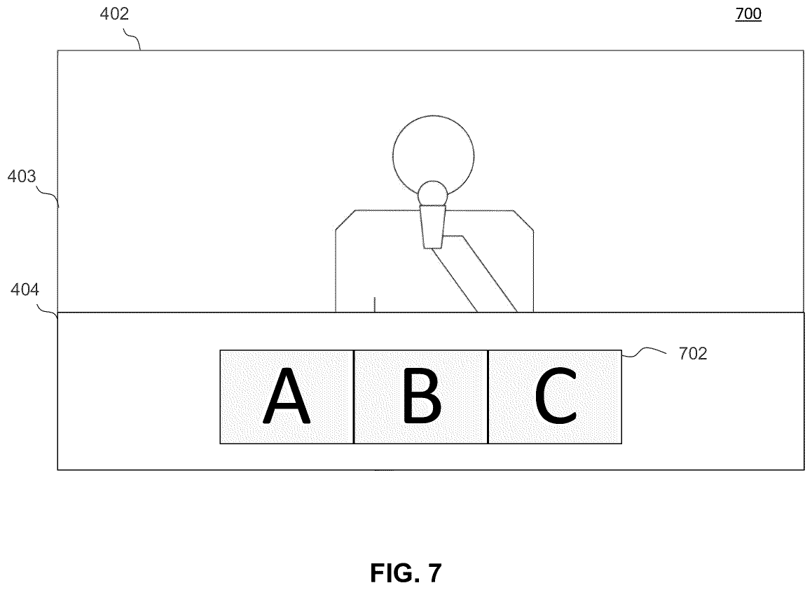

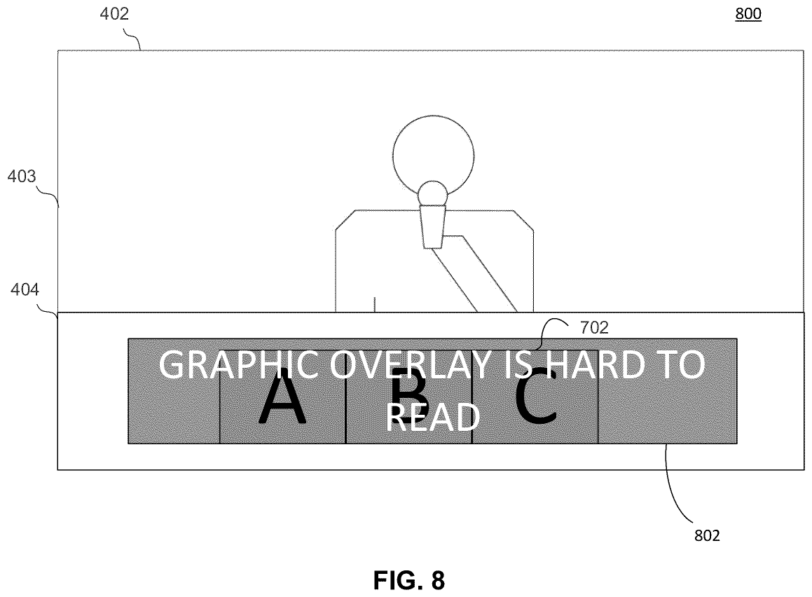

FIG. 7 illustrates a display screen of with graphics before addition of a graphic overlay, according to some embodiments. As shown, display screen 700 has a display area 402. In this non-limiting example, the media content includes a streamed or broadcast news report with multiple media content sections. In display area 403, a speaker may be discussing a news topic of interest. In display area 404, multiple graphics (A, B and C) 702 may be rendered. Graphics A, B, and C may be from a single source or be sourced separately (e.g., multiple streams). However, as will be illustrated in FIG. 8, a graphic overlay added to display area 404, may compete with the media content 702.

While shown in FIGS. 7-9 as a specific number of graphics (3) with varying media content (A, B and C), the display screen may be a single graphic or any number of graphics, and positioned in any configuration, without departing from the scope of the technology described herein.

FIG. 8 illustrates a display screen 800 of a graphic overlay before opacity modification, according to some embodiments. The technology as described herein improves the readability of graphic overlay 702 by increasing opacity using a blending factor as previous described. As shown, display device 800 has a display area 402. In this non-limiting example, the media content includes a streamed or broadcast news report with a multiple content sections. In display area 403, a speaker may be discussing a news topic of interest. In display area 404, multiple graphics (A, B and C) 702 and a graphic overlay 802 at least partially occupy a same display area (intersection of 702 and 802) and compete for the viewer's attention. However, as shown, the transparency of the graphic overlay has permitted the lower underlying layer of media content 606 (e.g., graphics as shown) to visually interfere with a viewer's ability to read the graphic overlay. In this scenario, the overlay graphic is hard to read.

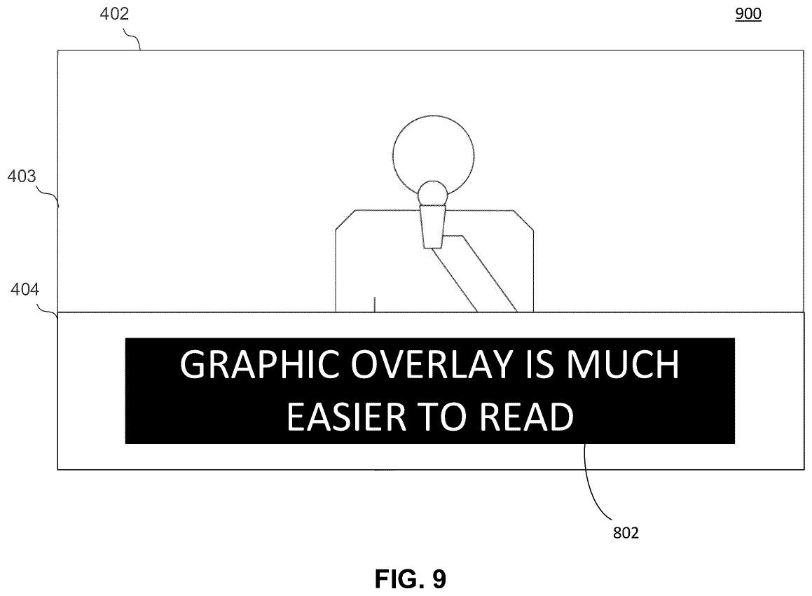

FIG. 9 illustrates a display screen 900 of a graphic overlay after opacity modification and position modification, according to some embodiments.

The technology as described herein improves the readability of graphic overlay 802 by increasing opacity using a blending factor as previous described. As shown, display screen 900 has a display area 402. In this non-limiting example, the media content includes a streamed or broadcast news report with a multiple content sections. In display area 403, a speaker may be discussing a news topic of interest. In display area 404, media content 702 (not visible) and a graphic overlay 802 at least partially occupy a same display area (intersection of 702 and 802) and compete for the viewer's attention. However, as shown, the opacity of graphic overlay 802 has been increased to remove or reduce a level of transparency that permitted the lower underlying layer of media content 702 to visually interfere with a viewer's ability to read the graphic overlay. In this scenario, the programming information of overlay graphic 802 is much easier to read.

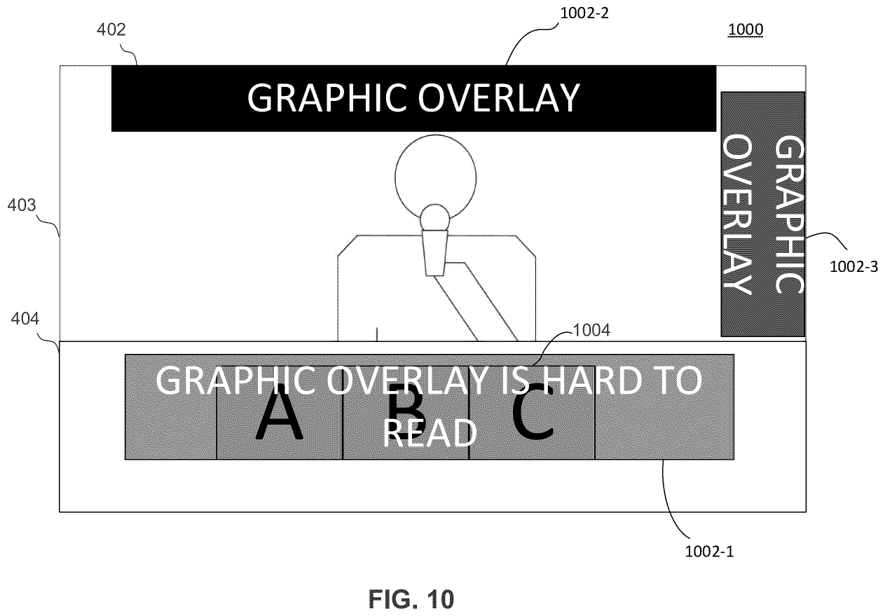

FIG. 10 illustrates a display screen 1000 of a graphic overlay after a position modification, according to some embodiments.

The technology as described herein improves the readability of a graphic overlay by increasing opacity using a blending factor as previous described. As shown, display screen 1000 has a display area 402. In this non-limiting example, the media content includes a streamed or broadcast news report with a multiple content sections. In display area 403, a speaker may be discussing a news topic of interest.

In some embodiments, contrast levels of a video background layer are analyzed to determine an optional placement of a graphical overlay based on analyzed inference with one or more sections of the underlying imagery. For example, as shown, graphic overlay 1002-1 is hard to read when overlaying existing media content 1004. In this embodiment, graphic overlay 1002-1 has been repositioned (1002-2 or 1002-3) to no longer occupy a same display area (404) with media content 1004 and no longer has to compete for the viewer's attention. While described for optional placement, the newly moved graphic overlay may incur, or incur at a future time, some underlying visual inferences and therefore may have its opacity adjusted (1002-2) as per earlier described embodiments. Alternately or in addition, the graphics processing system may resize the graphic overlay when moving to the new location. In some embodiments, the resizing is based on a preference to avoid underlying interference.

In one aspect, the high opacity overlay 1002-1 has been moved to occupy a blank or less busy area of the shown as 1002-2. For example, the histogram reveals areas where contrasting elements may not visually interfere with each other. For example, an area of a value of 0 in the histogram. In another aspect, the graphics processing system may choose a display area with a histogram value below a threshold, for example a value of 2 or below. In yet another aspect, the graphics processing system may select an area of the display where a smaller percentage of overlap exists. In this aspect, alternately or in addition, the graphics processing system may select an opacity level that, while higher than an original opacity, may still provide enough transparency to allow some viewer recognition of images displayed on a lower media content layer.

In another embodiment (not shown), text located under a graphical overlay may be processed to ascertain displayable text and this text relocated to another non-overlapping position. For example, news story text (or any text on the display screen) is actually an image of text, but may be converted from an image to recognizable text using known optical character recognition methods. This conversion may be performed in advance of rendering, for example, for commonly occurring areas of overlap, such as the bottom area 404 of the display screen or could be performed in real-time. Alternately, a snapshot image of the media content may be captured as its location and pixels are known in the frame buffer. Using either the recognizable text or the snapshot image, the news story text may converted to a graphic overlay using known overlay generation techniques and be repositioned in a graphic overlay to another area of the display screen, much like 1002-2 or 1002-3. In addition, once moved to another area of the display, this newly generated overlay may further take advantage of the technology described herein to improve readability through opacity modifications.

FIG. 11 illustrates a display screen with an evaluation area to detect brightness/contrast information, according to some embodiments.

Display screens are constructed as a matrix of pixels (picture elements). A pixel is the smallest unit of a digital image or graphic that can be displayed and represented on a digital display device. Pixels are combined to form a complete image, video, text, or any visible thing on a computer display.

To create the histogram of brightness/contrast values, the graphics processing system, in some embodiments, selects an evaluation area (e.g., zone) 1102 of a subset of the display pixels. The evaluation area is not limited in size, number of pixels or location, but may be determined by a size and placement of a graphic overlay that is being added (called up) to the frame buffer for subsequent rendering on the display screen.

As shown, a video frame 1104 is divided into a grid of blocks of pixels. The evaluation area 1102 of contiguous blocks is used to measure the overall contrast level for a large region of the screen.

In an exemplary embodiment, each block measures the contrast of that small area of the screen and assigns a contrast score from (0-3) as shown in FIG. 12. The contrast is a property of the display device 108, defined as the difference in brightness between objects or regions. Contrast score is defined as a scale 0-100 that measures the contrast levels of the background video 1102.

For example, as shown in FIG. 12, score 1206 has a value of 0=no contrast difference, where score 1204 has value of 3=the highest-level contrast difference. An intermediate score 1202 has a value of 2. All the block values are tallied up and the sum total (36 as shown) is passed on to the graphic overlay layer (e.g., UI presentation layer).

As previously described, a blending factor modifies the graphic overlay to be more or less opaque based on the contrast score passed to it. A triggering event represents a minimum degree of difference from one value to another between video frames to trigger an action, such as a change in opacity. As a non-limiting example, the triggering event may include a threshold value based on meeting or exceeding a percentage of blocks at a specific contrast difference score or an average score over a range of blocks or a mean score over a range of blocks. For example, a fully opaque overlay would not require an increase in opacity.

The end result is the screen graphic and text overlays become more legible over visually noisy, high-contrast video and graphics.

The technology as described herein provides benefits of increased readability for any graphic overlay (UI) superimposed over content or other UI to make the information presented more legible. The technology as described herein may be applied more broadly to any configurable aspect of the UI based on analyzing the image or video that is being displayed underneath it and adjusting one or more display parameters of one or more media content layers.

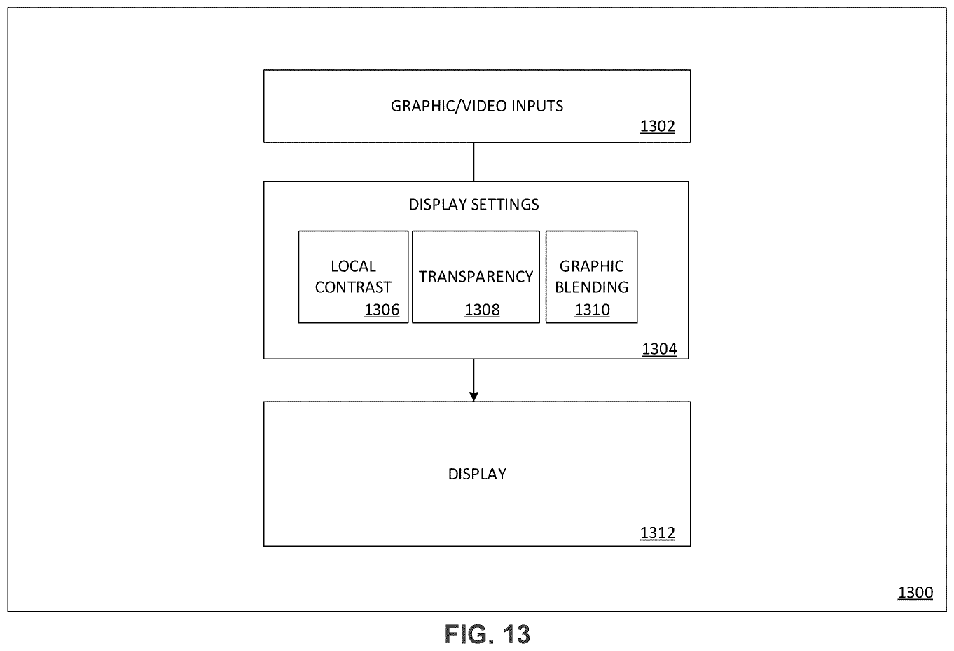

FIG. 13 illustrates a block diagram of an image processor system 1300, according to some embodiments.

In some embodiments, image processor system 1300 may be implemented as a video post-processing pipeline inside a System On a Chip (SOC). The SOC may be configured to enhance picture quality before video is rendered to display screen 1312. Display settings 1304 may be processed as part of the pipeline that takes graphic/video inputs and processes them to be displayed on a display screen 1312. In a non-limiting example, local contrast 1306, transparency 1308 and graphic blending 1310 are processed in the pipeline as described throughout the descriptions and figures. “Local contrast” 1306 may be hardware configured to process graphical overlays received as graphic input through graphic/video inputs 1302 (e.g., as received from a high definition media interface (HDMI), encoder or analog-to-digital converter). In local contrast 1306, each video frame is divided to sub-blocks for calculating the histogram (e.g., base Y channel), which will be used to enhance local contrast. A basket/bucket/bin number of a histogram may be variant with different SOCs (e.g., 16˜64). This histogram information in the frame buffer may be utilized by the local contrast for calculating the contrast. Sub-blocks may be variant from 512 to 2048 zones for different SOCs.

While FIG. 13 illustrates three display settings, additional display settings processed in the pipeline may include, but are not limited to, input selection, color, tone, temporal noise reduction, de-interlacing, noise reduction, scalar components, vector components, sharpness, luminance, chroma, frame rate conversion, local dimming, gamma white balance, dithering, de-mura, and overdriving.

While described herein for television media content, the various embodiments may be applied to any displayable media content, for example, Web-based media content, streamed or not streamed.

### Example Computer System

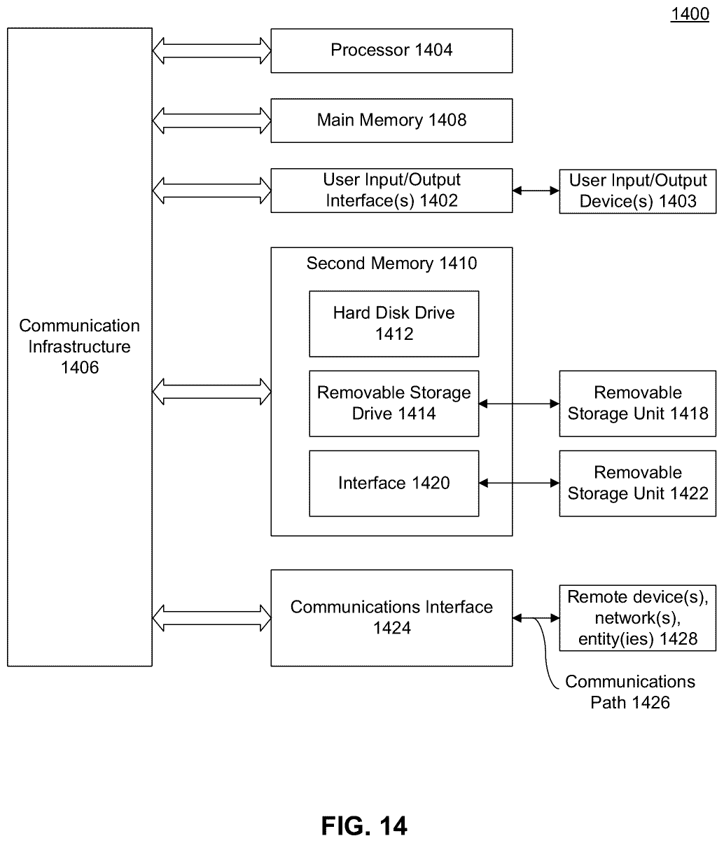

Various embodiments may be implemented, for example, using one or more well-known computer systems, such as computer system 1400 shown in FIG. 14. For example, the media device 106 may be implemented using combinations or sub-combinations of computer system 1400. Also or alternatively, one or more computer systems 1400 may be used, for example, to implement any of the embodiments discussed herein, as well as combinations and sub-combinations thereof.

Computer system 1400 may include one or more processors (also called central processing units, or CPUs), such as a processor 1404. Processor 1404 may be connected to a communication infrastructure or bus 1406.

Computer system 1400 may also include user input/output device(s) 1403, such as monitors, keyboards, pointing devices, etc., which may communicate with communication infrastructure 1406 through user input/output interface(s) 1402.

One or more of processors 1404 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1400 may also include a main or primary memory 1408, such as random access memory (RAM). Main memory 1408 may include one or more levels of cache. Main memory 1408 may have stored therein control logic (i.e., computer software) and/or data.

Computer system 1400 may also include one or more secondary storage devices or memory 1410. Secondary memory 1410 may include, for example, a hard disk drive 1412 and/or a removable storage device or drive 1414. Removable storage drive 1414 may be a floppy disk drive, a magnetic tape drive, a compact disk drive, an optical storage device, tape backup device, and/or any other storage device/drive.

Removable storage drive 1414 may interact with a removable storage unit 1418. Removable storage unit 1418 may include a computer usable or readable storage device having stored thereon computer software (control logic) and/or data. Removable storage unit 1418 may be a floppy disk, magnetic tape, compact disk, DVD, optical storage disk, and/any other computer data storage device. Removable storage drive 1414 may read from and/or write to removable storage unit 1418.

Secondary memory 1410 may include other means, devices, components, instrumentalities or other approaches for allowing computer programs and/or other instructions and/or data to be accessed by computer system 1400. Such means, devices, components, instrumentalities or other approaches may include, for example, a removable storage unit 1422 and an interface 1420. Examples of the removable storage unit 1422 and the interface 1420 may include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 1400 may further include a communication or network interface 1424. Communication interface 1424 may enable computer system 1400 to communicate and interact with any combination of external devices, external networks, external entities, etc. (individually and collectively referenced by reference number 1428). For example, communication interface 1424 may allow computer system 1400 to communicate with external or remote devices 1428 over communications path 1426, which may be wired and/or wireless (or a combination thereof), and which may include any combination of LANs, WANs, the Internet, etc. Control logic and/or data may be transmitted to and from computer system 1400 via communication path 1426.

Computer system 1400 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1400 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1400 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1400, main memory 1408, secondary memory 1410, and removable storage units 1418 and 1422, as well as tangible articles of manufacture embodying any combination of the foregoing. Such control logic, when executed by one or more data processing devices (such as computer system 1400 or processor(s) 1404), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 14. In particular, embodiments can operate with software, hardware, and/or operating system implementations other than those described herein.

### Conclusion

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for processing a video frame comprising:
determining, by a graphics computing system, a first graphic rendering area and position within the video frame of a graphical overlay located in a first layer of the video frame, wherein the graphical overlay comprises image pixels and text pixels;
calculating, by the graphics computing system, a location of video sub-blocks located in a second layer of the video frame, wherein the first layer of the video frame is above the second layer within the video frame and the video sub-blocks at least partially obfuscate the graphical overlay during rendering;
evaluating, by the graphics computing system, a histogram of the video sub-blocks aligned with the first graphic rendering area and position, wherein the histogram provides a first histogram value indicating an approximate first density of an underlying distribution of contrast differences;
when the first histogram value is above a threshold histogram value, evaluating the video sub-blocks not aligned with the first graphic rendering area for a second histogram value;
selecting, based on the second histogram value being below the threshold histogram value, a second graphic rendering area; and
relocating, within the video frame, the graphic overlay to the second graphic rendering area.

2. The method of claim 1, further comprising:
generating, as triggered by the histogram, a blending factor associated with each individual one of the image pixels and the text pixels of the first layer based on brightness and contrast contributions from a first pixel in the first layer and brightness and contrast contributions from a second pixel in the second layer, where the first pixel and second pixel are aligned within the second graphic rendering area.

3. The method of claim 2, further comprising:
increasing, by the graphics computing system and based on the blending factor associated with the each individual one of the image pixels and the text pixels of the first layer, an opacity of the image pixels and the text pixels of the graphical overlay, within the video frame, to increase a readability of the text based on the brightness and contrast contributions of the blending factor for the image pixels and the text pixels.

4. The method of claim 1, wherein the evaluating the histogram further comprises calculating a sum of contrast difference scores of the video sub-blocks for the second rendering area.

5. The method of claim 4, wherein the blending factor is triggered based on the sum of contrast difference scores exceeding a selected threshold.

6. The method of claim 1, wherein the calculating a location of video sub-blocks further comprises extracting, by the graphics computing system, pixel index information from a frame buffer corresponding to the second layer of the video frame aligned with the second graphic rendering area and position.

7. The method of claim 1, wherein the graphical overlay comprises a user interface providing media content control information for a viewer.

8. A graphics processing system, comprising:
a memory; and
at least one processor coupled to the memory and configured to perform operations comprising:
determining, by a graphics computing system, a first graphic rendering area and position within the video frame of a graphical overlay located in a first layer of the video frame, wherein the graphical overlay comprises image pixels and text pixels;
calculating, by the graphics computing system, a location of video sub-blocks located in a second layer of the video frame, wherein the first layer of the video frame is above the second layer within the video frame and the video sub-blocks at least partially obfuscate the graphical overlay during rendering;
evaluating, by the graphics computing system, a histogram of the video sub-blocks aligned with the first graphic rendering area and position, wherein the histogram provides a first histogram value indicating an approximate first density of an underlying distribution of contrast differences;
when the first histogram value is above a threshold histogram value, evaluating the video sub-blocks not aligned with the first graphic rendering area for a second histogram value;
selecting, based on the second histogram value being below the threshold histogram value, a second graphic rendering area; and
relocating, within the video frame, the graphic overlay to the second graphic rendering area.

9. The graphics processing system of claim 8, further comprising:
generating, as triggered by the histogram, a blending factor associated with each individual one of the image pixels and the text pixels of the first layer based on brightness and contrast contributions from a first pixel in the first layer and brightness and contrast contributions from a second pixel in the second layer, where the first pixel and second pixel are aligned within the second graphic rendering area.

10. The graphics processing system of claim 9, further comprising:
increasing, by the graphics computing system and based on the blending factor associated with the each individual one of the image pixels and the text pixels of the first layer, an opacity of the image pixels and the text pixels of the graphical overlay, within the video frame, to increase a readability of the text based on the brightness and contrast contributions of the blending factor for the image pixels and the text pixels.

11. The graphics processing system of claim 9, wherein the at least one processor is further configured to trigger the generation of the blending factor based on the total contrast difference score exceeding a selected threshold.

12. The graphics processing system of claim 8, wherein the at least one processor is further configured to perform operations calculating a total contrast difference score of the video sub-blocks in the histogram.

13. The graphics processing system of claim 8, further comprising a frame buffer and wherein the at least one processor is further configured to extract pixel index information from the frame buffer corresponding to the second layer of the video frame overlay aligned with the second graphic rendering area and position.

14. The graphics processing system of claim 8, wherein the contrast difference is based on differences in brightness and contrast.

15. A non-transitory computer-readable medium having instructions stored thereon that, when executed by at least one computing device, cause the at least one computing device to perform operations comprising:
determining, by a graphics computing system, a first graphic rendering area and position within the video frame of a graphical overlay located in a first layer of the video frame, wherein the graphical overlay comprises image pixels and text pixels;
calculating, by the graphics computing system, a location of video sub-blocks located in a second layer of the video frame, wherein the first layer of the video frame is above the second layer within the video frame and the video sub-blocks at least partially obfuscate the graphical overlay during rendering;
evaluating, by the graphics computing system, a histogram of the video sub-blocks aligned with the first graphic rendering area and position, wherein the histogram provides a first histogram value indicating an approximate first density of an underlying distribution of contrast differences;
when the first histogram value is above a threshold histogram value, evaluating the video sub-blocks not aligned with the first graphic rendering area for a second histogram value;
selecting, based on the second histogram value being below the threshold histogram value, a second graphic rendering area; and
relocating, within the video frame, the graphic overlay to the second graphic rendering area.

16. The non-transitory computer-readable medium of claim 15, generating, as triggered by the histogram, a blending factor associated with each individual one of the image pixels and the text pixels of the first layer based on brightness and contrast contributions from a first pixel in the first layer and brightness and contrast contributions from a second pixel in the second layer, where the first pixel and second pixel are aligned within the second graphic rendering area.

17. The non-transitory computer-readable medium of claim 16, increasing, based on the blending factor associated with the each individual one of the image pixels and the text pixels of the first layer, an opacity of the image pixels and the text pixels of the graphical overlay, within the video frame, to increase a readability of the text based on the brightness and contrast contributions of the blending factor for the image pixels and the text pixels.

18. The non-transitory computer-readable medium of claim 17, further configured to perform operations calculating a total contrast difference score of the video sub-blocks in the histogram.

19. The non-transitory computer-readable medium of claim 17, further configured to perform operations to trigger the generation of the blending factor based on the total contrast difference score exceeding a selected threshold.

20. The non-transitory computer-readable medium of claim 15, further configured to perform operations to extract pixel index information from a frame buffer corresponding to the second layer of the video frame overlay aligned with the second graphic rendering area and position.
